(19) United States
(12) Patent Application Publication
(10) Pub. No.: US 2007/0202912 A1
(43) Pub. Date: Aug. 30, 2007

(54) Transmission Line Power Supply for Energy Efficient Circuits

(75) Inventor: Jianbin Wu, Fremont, CA (US)

Correspondence Address: AKA CHAN LLP, 900 LAFAYETTE STREET, SUITE 710, SANTA CLARA, CA, 95050, US

(73) Assignee: Helix Micro, Inc., Milpitas, CA (US)

(21) Appl. No.: 11/381,412

(22) Filed: May 3, 2006

Related U.S. Application Data
(60) Provisional application No. 60/743,374, filed on Feb. 28, 2006.

(51) Int. Cl. H04B 7/00

(52) U.S. Cl. 455/522

(57) ABSTRACT

A transmission line supplies an alternating supply voltage to electronic circuits of a system. Energy is recycled using the transmission line. Energy from one circuit is discharged and stored in transmission, and this energy may be used subsequently to charge another circuit. The invention will materially contribute to the more efficient utilization and conservation of energy resources.

### CROSS-REFERENCE TO RELATED APPLICATIONS

This patent application claims the benefit of U.S. provisional patent application 60/743,374, filed Feb. 28, 2006, which is incorporated by reference along with all other references cited in this application.

### BACKGROUND OF THE INVENTION

The present invention is generally related to energy-efficient electrical circuits and, more particularly, to energy recycling techniques for operating electronic and logic circuitry with transmission power lines.

The present invention is based upon the general concept of an “EM-Cell,” an electric-magnetic energy pool in which the load, or application, circuits are treated as energy dissipation structures in the EM-Cell, as illustrated in FIG. 1A. The behavior of the electric-magnetic field is time-modulated to minimize energy dissipation. The EM-Cells can be mutually coupled such as shown in FIG. 1B to create larger energy-efficient systems. Electrical systems which can benefit from the present invention include electric cars, portable computers, even wireless telephone systems, including base stations and handsets, such as shown in FIG. 1C.

With the development of VLSI (Very Large Scale Integration) fabrication technology and the advent of submicron, or even nanometer, geometries in recent years, the levels of integration in digital integrated circuitry have greatly increased. There has been a corresponding increase in the speeds and functionalities of such circuitry. While these trends permit increased capabilities for the electronics consumer, there has developed a major problem, i.e., the exorbitant power consumption of these devices. For example, the current advanced processors, while having exceptional performance, also have exceptional power dissipation-in the range of about 80 to 100 watts. High power consumption renders many applications extremely expensive, if not impossible, due to the requirements of special packaging and cooling facilities.

Additionally, many portable electronic devices, such as laptops and cellular telephones, demand integrated circuitry with higher and higher performances. However, battery system technology simply has not kept pace with these demands so that current batteries cannot power these devices for significantly useful periods. To make matters worse, many portable or mobile systems have physical size constraints that preclude the use of extensive cooling devices to remove heat, the dissipated power, from the integrated circuitry.

Furthermore, due to the pervasive use of electronic devices in modern societies, energy consumption by integrated circuits has become one of the major factors of the total human energy usage, and that portion is growing continually. For example, in New York City some estimates place integrated circuit energy consumption at greater than 30 percent.

Therefore, there is a need for high-speed, high-functionality integrated circuits which have very low power consumption without depending on low supply voltages to achieve the reduction in power consumption. To address these problems, the EM-Cell of the present invention can be scaled downward in size for application to integrated circuit technology in which logic circuits are treated as the loads, the dissipation structures, in an EM-Cell. In practical terms, the present invention, among other advantages, allows portable electronic devices to achieve higher performances and greater functionalities. The need for special cooling equipment is avoided or substantially reduced and the battery life of portable electrical equipment is greatly extended.

### BRIEF SUMMARY OF THE INVENTION

The present invention also provides for an electrical circuit system for performing applications. The electrical circuit system has an electrical circuit which is adapted to perform the applications; a transmission line connected to the electrical circuit so that the transmission line supplies power to the electrical circuit, the electrical circuit operating as a load on the transmission line; and a transceiver connected to the transmission line in a loop to transmit signal waveforms on the transmission line to power the electrical circuit and to receive the power supply signal waveforms after powering the electrical circuit. The transceiver times and reforms the signal waveforms to compensate for any energy dissipation by the transmission line and the electrical circuit. Energy carried on the transmission line is recycled and power dissipation of the electrical circuit system is substantially reduced.

Furthermore, the present invention provides for a method of adapting an electrical circuit system for performing applications on reduced power. The method comprises connecting an electrical circuit adapted to perform the applications to a transmission line so that the transmission line supplies power to the electrical circuit, the electrical circuit operating as a load on the transmission line; connecting a transceiver to the transmission line in a loop so that the transceiver transmits signal waveforms on the transmission line to power the electrical circuit and receives the power supply signal waveforms after powering the electrical circuit; and setting the transceiver to time and reform the signal waveforms to compensate for any energy dissipation by the transmission line and the electrical circuit; whereby energy carried on the transmission line is recycled and power dissipation of the electrical circuit system is substantially reduced.

In a specific implementation, the invention is an integrated circuit including a transmission line structure comprising an active conductor and a ground plane conductor, where the active conductor carries an alternating power supply signal. There is a first electronic circuit having a power connection coupled to the active conductor. There is a second electronic circuit having a power connection coupled to the active conductor.

In a specific implementation, the invention is a method of operating an electronic circuit including: providing a transmission line structure as an energy source for the electronic circuit; during a first time period, capturing first energy from a first logic transition of a first circuit of the electronic circuit in the transmission line structure; and during a second time period, supplying energy, which includes the first energy, from the transmission line structure to enable a second logic transition of a second circuit of the electronic circuit.

In a specific implementation, the invention is a method of operating an electronic circuit including: storing energy in a transmission line structure; operating a logic circuit using the stored energy to determine a logic output based on at least one logic input to the logic circuit during a first phase; capturing in the transmission line structure connected to the logic circuit a portion of the stored energy during the operation of the logic circuitry; and transferring a portion of the captured energy back in the transmission line structure during a second phase.

The invention will materially contribute to the more efficient utilization and conservation of energy resources. The invention will reduce of energy consumption in numerous devices and systems including electronics, computers, printers, portable and handheld electronics, console, and consumer electronics. Furthermore, this invention will decrease U.S. dependence on fossil fuels.

The invention is especially suited for creating highly efficient electronic systems, where a goal is to provide power with the voltage and current to a load with minimum losses, thus greatly improving the efficient utilization of energy resources, and recycling the energy so energy is not wasted. The load can be a computer, portable electronics, circuitry in motorized vehicles, industrial equipment, household electronics and appliances, or any other device requiring power.

### BRIEF DESCRIPTION OF THE DRAWINGS

These and other features, aspects and advantages of the present invention will become better understood with regard to the following description, appended claims, and accompanying drawings where:

FIG. 1A is a general representation of an EM-Cell of the present invention and power dissipating applications;

FIG. 1B is a general representation of several coupled EM-Cells;

FIG. 1C shows possible applications of the EM-Cell;

FIG. 2 shows a conventional CMOS inverter circuit;

FIG. 3 shows the electromagnetic field distribution in the microstrip transmission line;

FIG. 4A is a model of the current and voltage of a microstrip transmission line model;

FIG. 4B shows the resistive-capacitive-inductive-conductive model of a transmission line segment;

FIG. 4C further includes a resistive-capacitive load to transmission line segment model;

FIG. 4D is a model transmission line with source and load impedances;

FIGS. 5A and 5B shows the signal waveform distortion when the signal waveform propagates along the transmission line with resistive-capacitive loads.

FIG. 6A shows a loaded transmission line loop driven by a signal waveform transceiver;

FIG. 6B is an illustrative diagram for the signal waveform transceiver of FIG. 6A;

FIG. 7A illustrates a variation of the signal waveform transceiver for the transmission line, according to another embodiment of the present invention;

FIG. 7B illustrates an arrangement of the FIG. 7A signal waveform transceiver;

FIG. 7C details the FIG. 7B arrangement;

FIG. 8A is a model of dynamic logic gates which are used as application loads of the transmission lines, according to one embodiment of the present invention;

FIG. 8B is an exemplary two-input NAND dynamic logic gate and the timing between the logic gate inputs and the voltage supply signal waveform of the transmission line;

FIG. 9 is a representation of a transmission line loop, the interconnected dynamic logic gates which are the loads to the transmission line and the transceiver which drives the transmission line, according to one embodiment of the present invention.

FIG. 10A shows an arrangement in which one transceiver drives multiple transmission line loops according to still another embodiment of the present invention;

FIG. 10B is a variation of the FIG. 10A arrangement in which the received signal waveform from one transmission loop is used to drive another transmission loop after being properly conditioned and timed by the transceiver;

FIG. 10C illustrates the entire system of FIG. 10B;

FIG. 11 illustrates a waveform transceiver as a repeater along transmission line to recover the waveform distortion according to one embodiment of the present invention; and

FIG. 12 shows an implementation of the invention in a rechargeable battery environment.

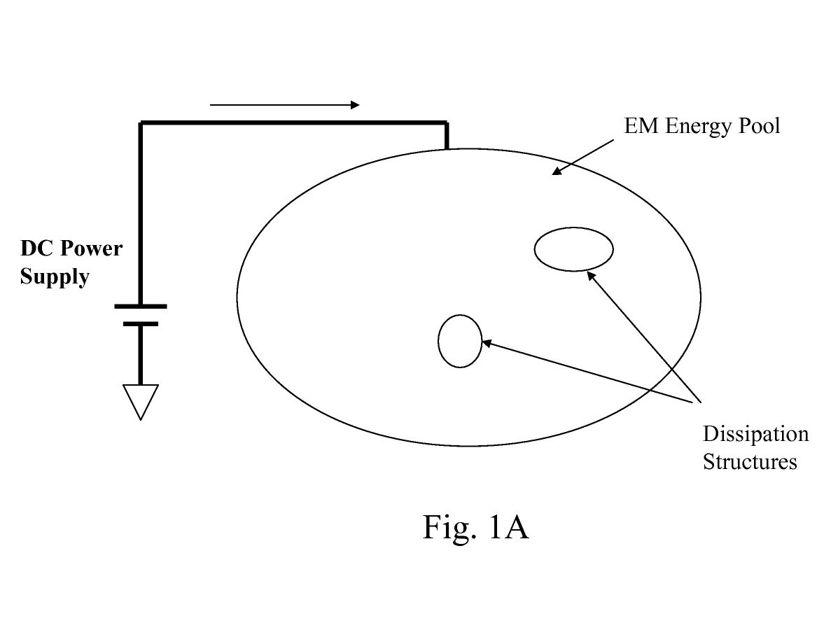

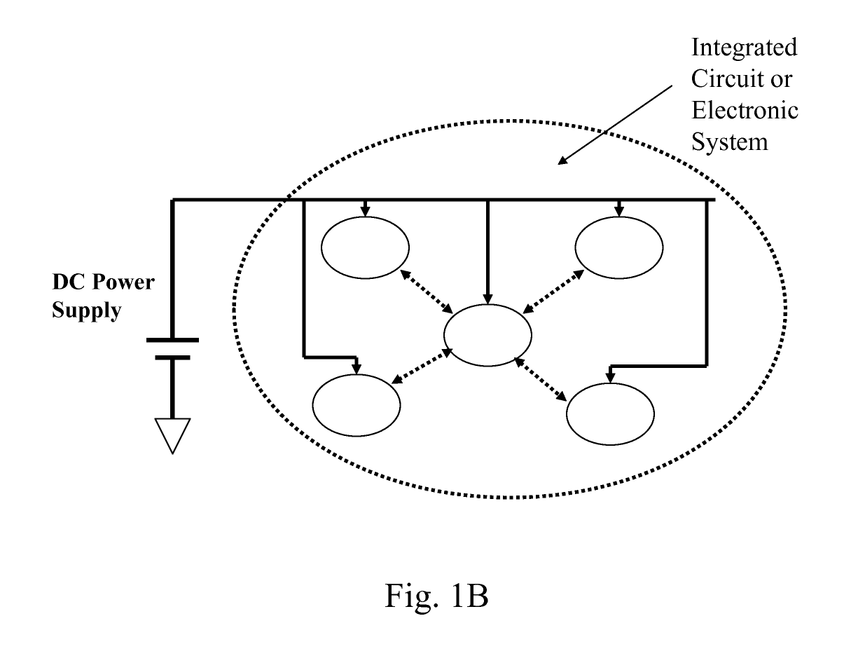

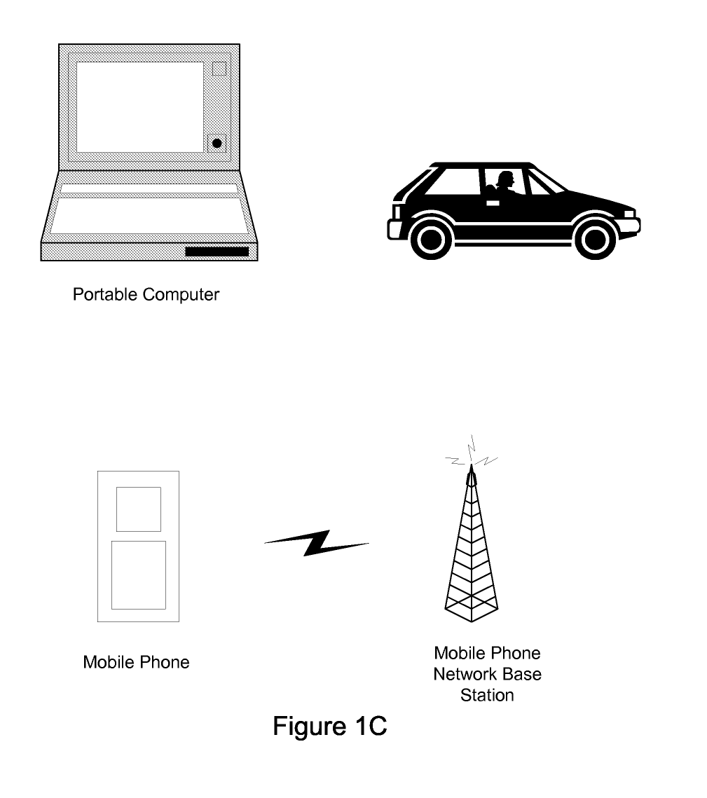

### DETAILED DESCRIPTION OF THE INVENTION

Most of the current high-performance, high-power, digital integrated circuits are based on CMOS (Complementary Metal-On-Silicon) technology. Power consumption for CMOS circuits is the sum of static power dissipation, P_{S}, and dynamic power dissipation, P_{D}. P_{S} is the result of the leakage current, while P_{D} is the sum of the transient power consumption, P_{T}, and the capacitive-load power consumption, P_{L}. The transient power consumption, P_{T}, in turn, results from the current that travels between the power supply and ground (known as the through current) when the CMOS device switches states and the current required to charge and discharge internal switching nodes within the device (known as the switching current); the charging and discharging of internal nodes typically dominates P_{T}. The capacitive-load power consumption, P_{L}, is caused by charging and discharging an external load capacitance.

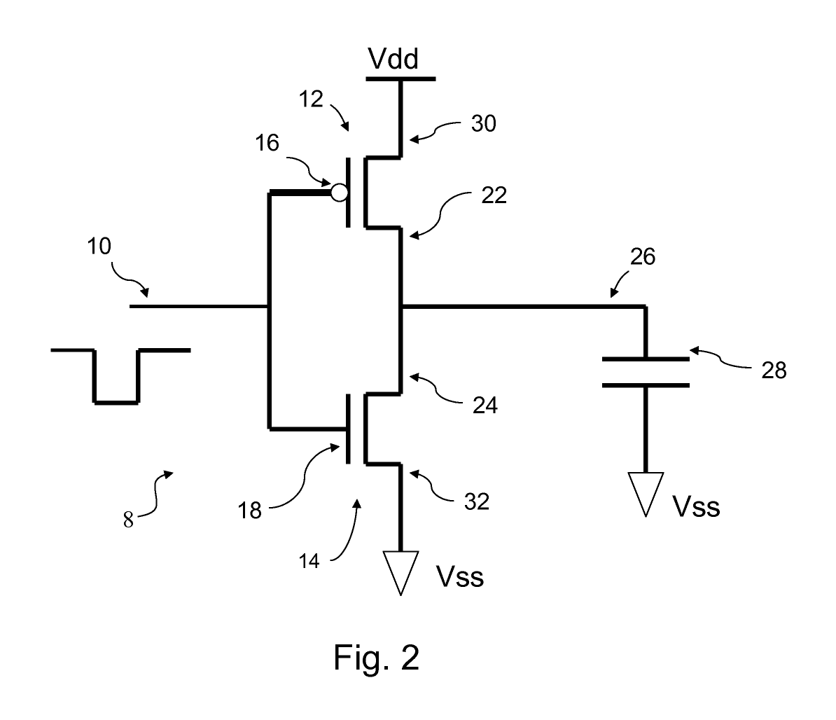

FIG. 2 shows a typical CMOS inverter circuit 8 which includes a p-channel MOS transistor 12 and an n-channel MOS transistor 14. Gates 16, 18 of the transistors 12, 14 respectively are connected together and to an inverter circuit input 10. The commonly connected drains 22, 24 of the transistors 12, 14 are connected to an inverter circuit output 26. The source 30 of the p-channel transistor 12 is connected to the voltage supply, V_{dd}, and the source 32 of the n-channel transistor 14 is connected to ground (Vₛₛ). The output of the inverter 26 is connected to other CMOS circuitry whose loading characteristics are capacitive in nature. This external capacitive loading is modeled by a capacitor 28 connected to the inverter output 26. When the input 20 to the logic circuit 8 is driven low, logic ZERO, the p-channel transistor 12 turns on, causing the capacitive load 28 with a value C_{L} to be charged from the voltage supply, V_{dd}, through the p-channel transistor 12 and registering a logic ONE at the output 26. Similarly, when the input 10 is driven high, logic ONE, the p-channel transistor 12 turns off and the n-channel transistor 14 turns on, allowing charge stored in the capacitive load 32 to be discharged through the n-channel transistor 14 to ground, thus registering a logic ZERO at the output 26.

The power dissipation of the logic gate 8 includes three components, the first component being the leakage current. Even though the logic gate 8 is in a static state, namely, either the transistor 14 is turned off, with the input voltage equal to VSₛₛ, or the transistor 12 is turned off with the input voltage equal to V_{dd}, there is a direct current from power supply (V_{dd}) to the ground (Vₛₛ). The power dissipation from this leakage current is Iₗₑₐₖ·V_{dd}. In today's most advanced fabrication technologies, such as 0.09 μm and 0.065 μm process technologies, the power leakage in an integrated circuit could be in the order of watts, if the integrated circuit has tens of million logic gates.

The second component of the power dissipation in the logic gate 8 is due to the transient current. The transient current is the current from the power supply V_{dd} to ground Vₛₛ, when both transistors 12 and 14 are turned on as the input signal is switched from low (Vₛₛ) to high (V_{dd}). The transient current is minimized by careful signal and gate designs.

The third component of the power dissipation in the logic gate 8 is due to the charging and discharging of the output capacitive loading. Each cycle of the input signal results in a transfer of charge to and from the capacitive load, which is equivalent to an energy transfer of (½C_{L}·ΔV_{C}²) to charge and (½C_{L}·ΔV_{D}²) to discharge the capacitive load, where C_{L} is the value of the capacitive load, ΔV_{C} is the change in voltage across the capacitive load when charging the load and ΔV_{D} is the change in voltage across the capacitive load when discharging the load. This energy, ½C_{L}·(ΔV_{C}²+ΔV_{D}²), is dissipated as heat. Ultimately, the dynamic energy, on the order of 10⁻¹² Joules (assuming C_{L} to be about 1 pf, which includes the load and wiring capacitance, and ΔV to be about a volt), used to operate the circuit of FIG. 2 over a single cycle, is lost.

Furthermore, if the cycle of charging and discharging occurs at a frequency f, then the power consumed by the circuit of FIG. 2 is approximately f·C·ΔV₂, where equal voltage changes are assumed for charging and discharging. Currently, the operational frequency of CMOS circuits is as high as 10⁹ Hz. This means that even though the energy consumed over one cycle by a simple CMOS gate is very low, the power consumed when a gate is operated continuously at very high frequencies can be appreciable (on the order of 100 microwatts). When there are millions of such gates on a semiconductor die, the problem is again multiplied resulting in hundreds of Watts being consumed and a large fraction of that power being dissipated as heat.

A common approach to alleviate this problem has been to reduce the supply voltage because the savings in power consumption is proportional to the square of the voltage reduction. However, a reduction of the power supply voltage causes other problems which include increased susceptibility of the circuit to noise and increased transistor leakage current because the threshold voltage of the MOS transistors must be reduced to permit the devices to operate on the lower supply voltage. In fact, to a certain level, the voltage swing has a limit: 0.13 μm processes use 1.2V, while 0.09 μm processes use 1.0V.

General Concepts

The high power dissipation in the CMOS circuits is caused mostly by energy consumption directly from the DC power supply by the digital circuits whenever the digital circuits require energy. With the present invention, the DC power supply through highly efficient conversion is to create an EM-Cell. Through a well-adapted transmission line system, a time-modulated electric field in the EM-Cell is used to drive the dissipation structures, namely, the CMOS logic gates which are attached to the transmission line system and form its loads. If the time behavior of the electric field of the transmission line system is well controlled, the energy dissipation through the dissipation structures is significantly reduced. The signals propagated on the transmission line are amplified to compensate the energy loss along the transmission line and the dissipative loss in the logic gates. The recirculation of these pulsed signals on the transmission line realizes energy recycling and energy is conserved.

In accordance with the present invention, an integrated circuit or an electronic system comprises the EM-Cells, and the DC power supply standby is regarded as the source to maintain the stability of the EM-Cells. A well-designed transmission line structure is introduced to build the EM-Cell, and the logic loadings, which are attached to the transmission line, are treated as dissipation structures. Under certain time-constraint conditions to the electric field in the transmission line, the dissipation is significantly reduced without adversely impacting the operation of the logic gates.

Theoretical Background

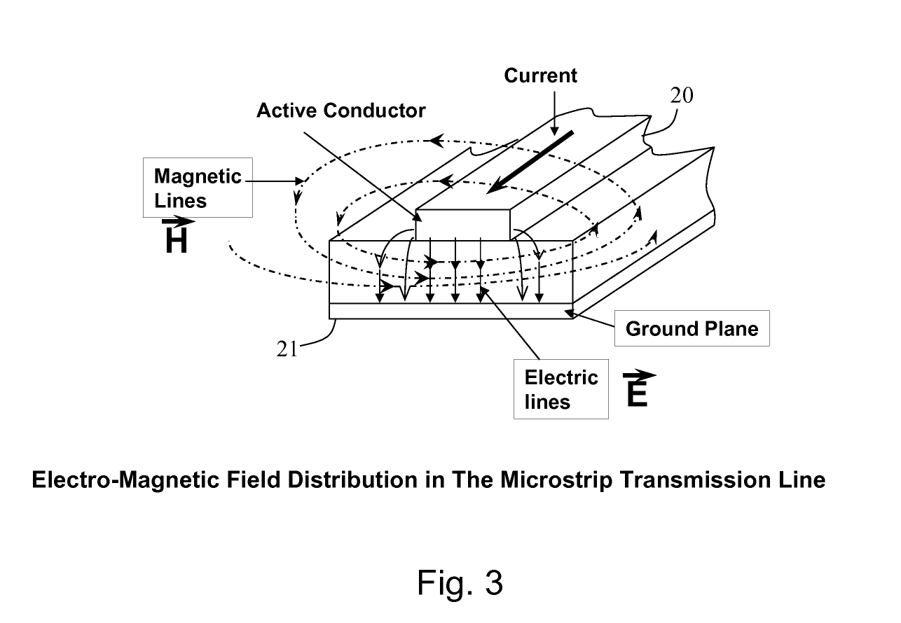

FIG. 3 shows a perspective view of a cross-section of a transmission line structure. This structure may be fabricated on or within an integrated circuit. There is an active conductor (or signal conductor) and a ground plane. The ground plane runs in parallel to the signal conductor. The ground plane may be run below (as shown) or above the active conductor, and generally runs the entire length of the conductor. The ground plane may be run on one side or multiple sides of the active conductor, or may even be formed to surround the active conductor on all sides. The ground plane is typically a wider run than the active conductor run.

The conductor may be any formed from any conductive material including metal, aluminum, copper, metal alloys, polysilicon, polysilicide, and many others. The active conductor may be of the same conductive material as the ground plane conductor, or a different conductive material from the ground plane conductor. A width of the active conductor run may be selected based on the amount of current the active conductor will be expected to carry.

For example, in a semiconductor process, the transmission line structure may include a signal conductor on a first layer of metal and a ground plane conductor on a second layer of metal, different from the first layer of metal. There may be multiple ground planes, above and below the signal conductor. The layers of metal are typical separated by an interlayer dielectric, such as silicon oxide.

There are many other types of transmission line structures and any of these may be used in the invention. An example of another transmission line structure is a coaxial cable structure.

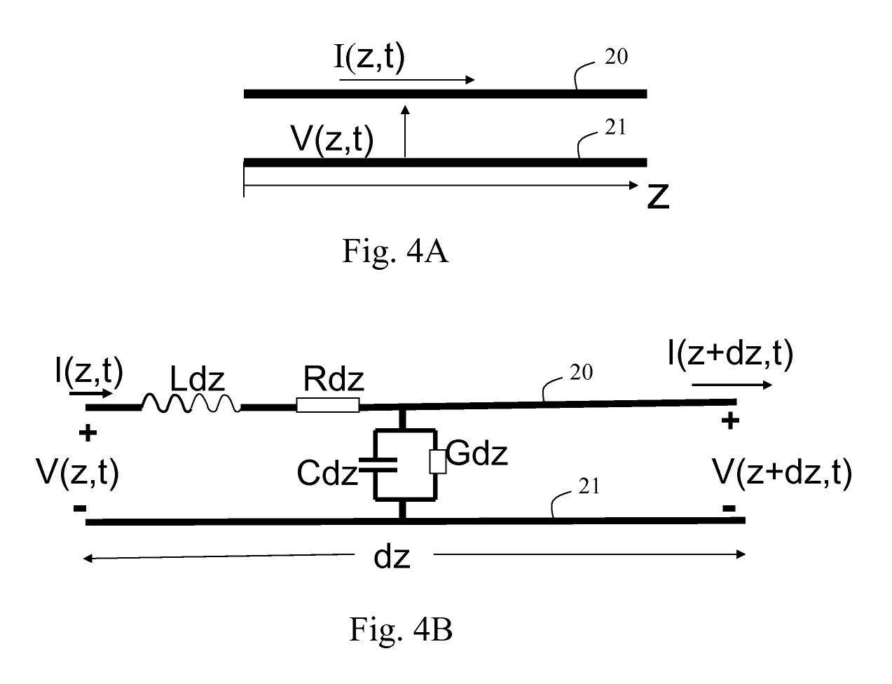

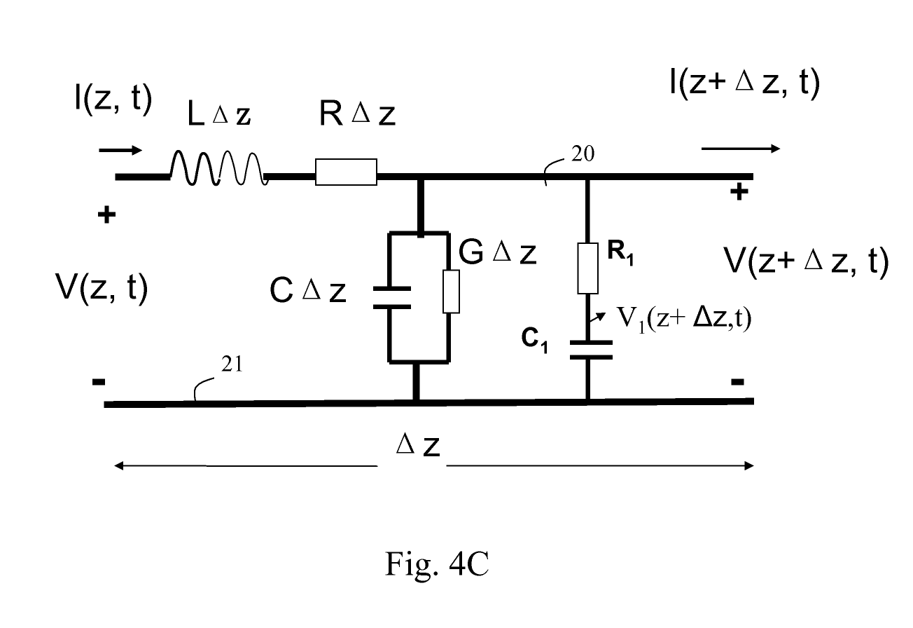

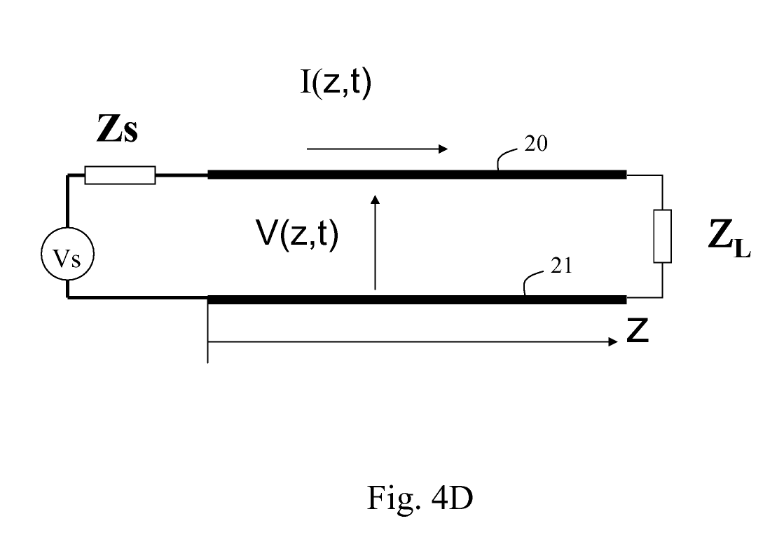

The electromagnetic wave propagates along a transmission line as a transverse wave. FIG. 3 schematically illustrates the electric and magnetic field distribution along the microstrip-type transmission line which is formed by a microstrip line 20 and a reference conductor, a ground plane 21. Generally speaking, the fields could be described by the current along the transmission line and the voltage across the strip line 20 and the reference conductor 21, as shown in FIG. 4A. FIG. 4B is the typical model for a transmission line, where R, L, C are the corresponding resistance, inductance, and capacitance per unit length along the z-direction. The current and voltage at coordinate z and time t are I(z,t), V(z,t) respectively. G is the conductance of the dielectric media per unit length along the transmission line. Now suppose a uniformly distributed loading is connected to the transmission line, and if the corresponding load is R₁_{, C}₁ per Δz in length, one segment of the loaded transmission line is modeled in FIG. 4C.

For a lossy transmission line as modeled by FIG. 4B, the equations to govern the behavior of I(z, t) and V(z, t) are as follows:

$$\begin{matrix}- \frac{\partial I ( z , t )}{\partial z} = GV ( z , t ) + C \frac{\partial V ( z , t )}{\partial t} & ( 1 ) \\ - \frac{\partial V ( z , t )}{\partial z} = RI ( z , t ) + L \frac{\partial I ( z , t )}{\partial t} & ( 2 )\end{matrix}$$

Multiplying Equation (1) by V(z,t) and Equation (2) by I(z, t) result in:

$$\begin{matrix}- V ( z , t ) \frac{\partial I ( z , t )}{\partial z} = {GV ( z , t )}^{2} + C \frac{\partial ( {V ( z , t )}^{2} ) / 2}{\partial t} & ( 3 ) \\ - I ( z , t ) \frac{\partial V ( z , t )}{\partial z} = {RI ( z , t )}^{2} + LI ( z , t ) \frac{\partial I ( z , t )}{\partial t} & ( 4 )\end{matrix}$$

Then the sum of Equations (3) and (4) yields:

$$- \frac{\partial [ I ( z , t ) V ( z , t ) ]}{\partial z} = {RI ( z , t )}^{2} + {GV ( z , t )}^{2} + \frac{\partial [ {LI ( z , t )}^{2} + {CV ( z , t )}^{2} / 2 ]}{\partial t}$$

Defining ε(z,t)=(LI(z,t)²+CV(z,t)²)/2, and p(z,t)=I(z,t)V(z,t), we have

$$- \frac{\partial [ I ( z , t ) V ( z , t ) ]}{\partial z} = \frac{\partial ɛ ( z , t )}{\partial t} + [ {RI ( z , t )}^{2} + {GV ( z , t )}^{2} ] \qquad ( 5 )$$

Equation (5) means the power flows into the transmission line segment (z, z+dz),

$$\frac{\partial p ( z , t )}{\partial z} ,$$

is equal to the energy storage increase rate in the segment,

$$\frac{\partial ɛ ( z , t )}{\partial t} ,$$

plus the power dissipated [RI(z,t)²+GV(z,t)²], due to ohmic and dielectric dissipation. Note that if dissipation is negligible, the energy storage increase is equal to the energy flowing into the segment (z, z+dz) from the neighboring segments. Equation (5) can also be understood that the energy storage loss in the transmission line segment (z, z+dz) equals the energy dissipated in the segment plus the energy flowing out of the segment along the transmission line. Therefore, if some circuit load is attached to the segment (z, z+dz), the recovery of the energy flowing out of the segment back to the segment (z, z+dz) for re-use is also a form of energy recycling.

Returning to the transmission line segment of FIG. 4C, the variation of I(z, t) and V(z, t) satisfies the following equations:

$$\begin{matrix}- [ V ( z + Δ z , t ) - V ( z , t ) ] / Δ z = RI ( z , t ) + L \frac{\partial I ( z , t )}{\partial t} & ( 6 ) \\ - I ( z , t ) - G * Δ z * V ( t , z ) - C * Δ z * \frac{\partial V ( z + Δ z , t )}{\partial t} & \\ - \frac{[ {V}_{1} ( z + Δ z , t ) - V ( z + Δ z , t ) ]}{{R}_{1}} - I ( z + Δ z , t ) = 0 & ( 7 ) \\ V ( z + Δ z , t ) - {V}_{1} ( z + Δ z , t ) = {R}_{1} {C}_{1} \frac{\partial V ( z + Δ z , t )}{\partial t} & ( 8 )\end{matrix}$$

If the time variation of V₁(z+Δz, t) is very small so that the variation time scale dt>>R₁.C₁, Equation (7) becomes

$$I ( z , t ) - G * Δ z * V ( z , t ) - [ C * Δ z + {C}_{1} ] \frac{\partial V ( z + Δ z , t )}{\partial t} \\ - {R}_{1} * {C}_{1} \frac{{\partial }^{2} V ( z + Δ z , t )}{\partial {t}^{2}} - I ( z + Δ z , t ) = 0 \qquad ( 9 )$$

In the frequency domain, Equation (9) becomes:
I(z,ω)−G*Δz*V(z,ω)+[C*Δz+C₁]*jωV(z+Δz)−R₁*C₁*V(z+Δz,ω)*ω²−I(z+Δz,ω)=0 (10)

Therefore, if R₁*C₁<<1/ω, the term, −R₁.·C₁.·V(z+Δz, ω)·ω², which is due to the ohmic dissipation of R₁, is negligible. Namely, if the time variation of V(z+Δz, t) is slow enough, compared to the load intrinsic delay R₁.·C₁, the loaded transmission line behaves as a normal transmission line with the capacitance C+C₁/Δz.

The power dissipation on the load R₁·C₁ is therefore minimized by optimizing the waveform of V(z, t) on the transmission line.

The source and load impedances impact the transmission line performance. If one assumes a transmission line driven by Vs, with source impedance Zs, and terminated with Z_{L}, the load impedance as shown in FIG. 4D, then the source reflection coefficient is given by:

$${Γ}_{S} = \frac{{Z}_{S} - Z 0}{{Z}_{S} + Z 0} \qquad ( 11 )$$

where Z0 is the transmission line intrinsic impedance, (L/C)^{1/2}.

The load reflection and transmission coefficients respectively are:

$$\begin{matrix}{Γ}_{L} = \frac{{Z}_{L} - Z 0}{{Z}_{L} + Z 0} & ( 12 ) \\ {T}_{L} = \frac{2 {Z}_{L}}{{Z}_{L} + Z 0} & ( 13 )\end{matrix}$$

Γs is the measure of efficiency of injection energy from the source supply, and Γ_{L} indicates the energy reflection back to the transmission line load.

### DESCRIPTION OF THE INVENTION

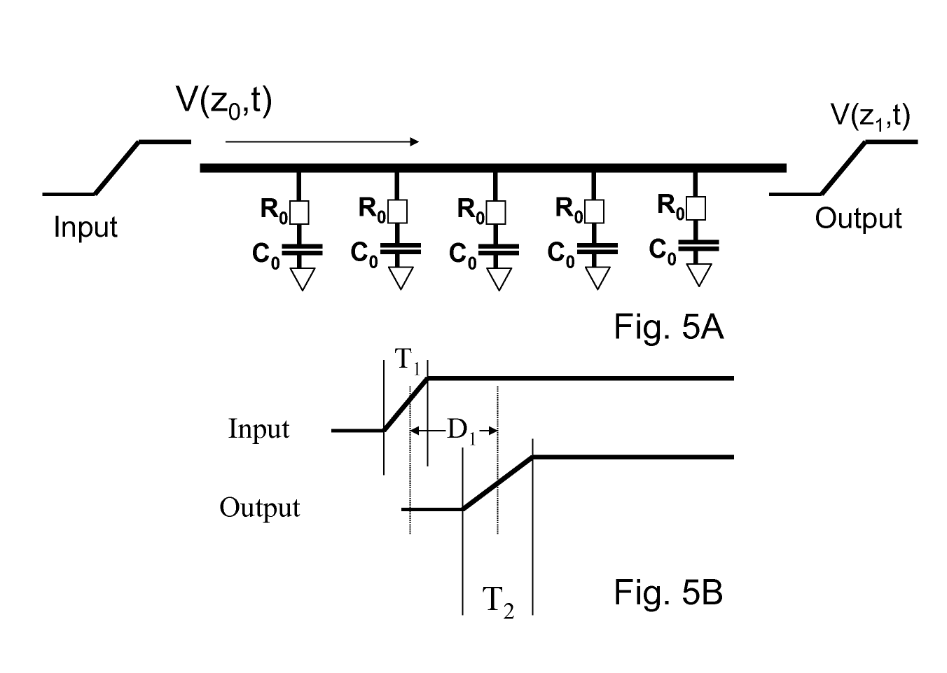

If the transmission line has a uniformly distributed load as illustrated in FIG. 5A, the unit length loading is resistive load times the capacitive load, i.e., R₀,·C₀, the rising edge of the transmission line input waveform V(z₀, t) has a rise time T₁, shown in FIG. 5B, much greater than R₀.·C₀. Furthermore, the reflection from the output is assumed to be negligible. Then the waveform propagation along the line has only delays. The output waveform V(z₁, t) therefore only has delay, with the modulation of the rise time, to T₂, shown in FIG. 5B. The amplitude of V(z₁, t) is smaller than V(z₀,t), due to the energy dissipation along the line. If the loading capacitors C₀'s need to be periodically charged/discharged, the input waveform and therefore the output waveform also has periodic charging and discharging phases.

The power dissipation along the transmission line is dominated by the intrinsic ohmic dissipation along the transmission line. As previously mentioned in the CMOS circuit description, if the total loading is driven by the CMOS circuit, the power dissipation should be ΣC0·V²·f, where C0 is the distribution capacitive loading, V is the voltage amplitude, and f is the frequency to charge and discharge the loading capacitors, ΣC0.

So far, if the input represents the energy injection into the transmission line, the output represents the energy flowing from the line, less a certain amount of dissipation. In accordance with the present invention, the output energy is recycled. The logic circuitry in this invention is dynamic logic gate, which can be modeled as a digital signal-controlled RC circuit.

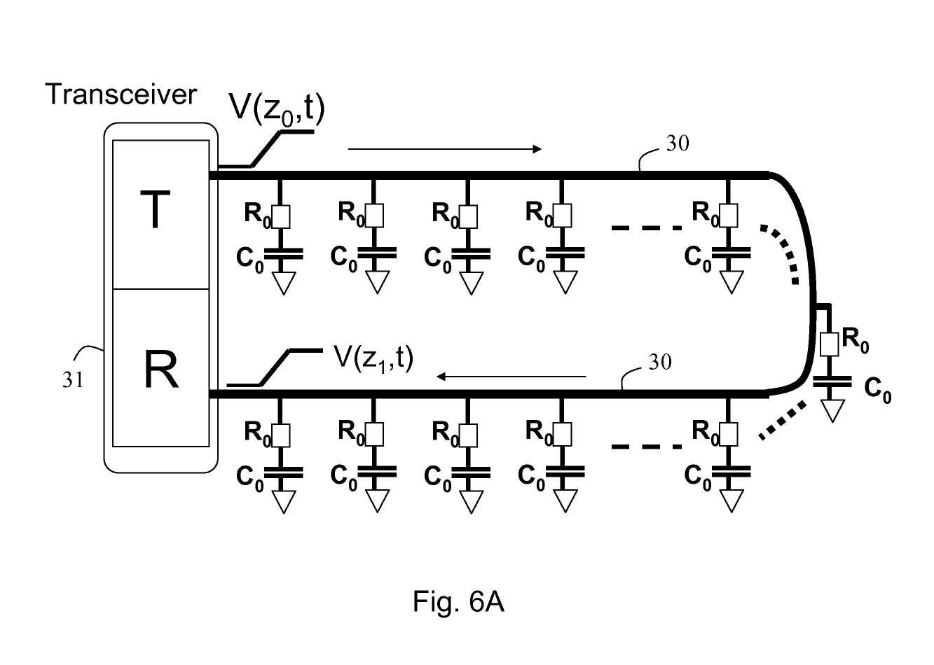

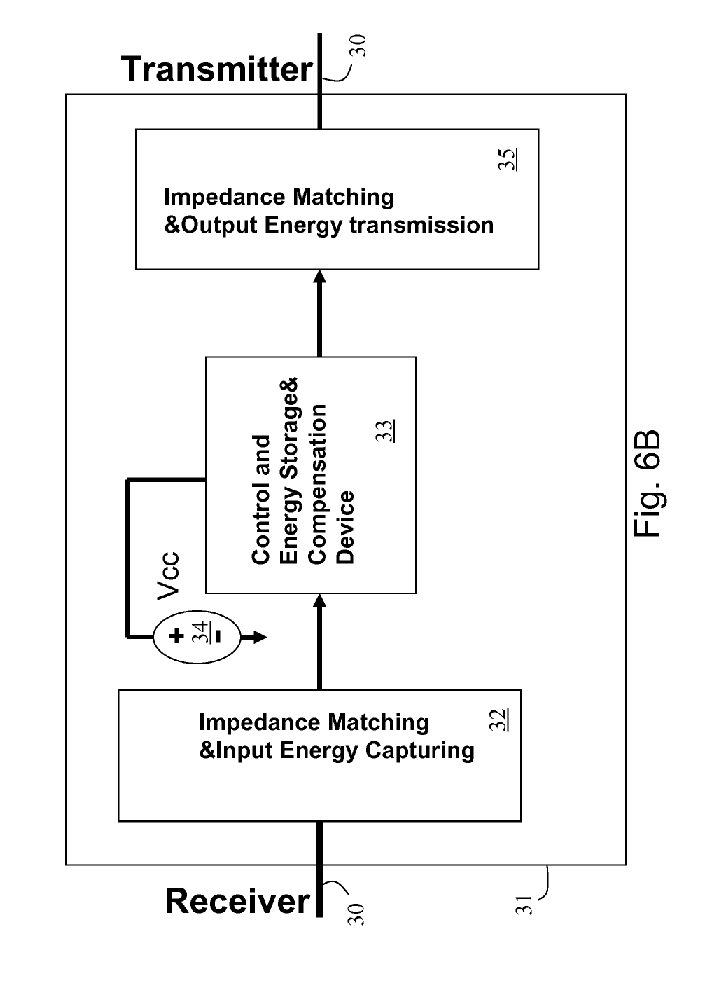

FIG. 6A is a schematic illustration of energy recycling in accordance with one embodiment of the present invention. A transceiver 31 connects the input and output terminals of a transmission line 30 to form a loop. In this manner, the combined transceiver 31 and transmission line 30 forms a large energy pool, and the electro-magnetic energy travels around the loop with the form of voltage/current. The transceiver 31 receives, amplifies, reshapes and transmits the energy waveforms to drive the loaded transmission line 30. As pointed out earlier, in order to minimize power dissipation, the rise/fall time of the transmission input waveform V(z₀, t) is much greater than the load intrinsic delays, R0·C0.

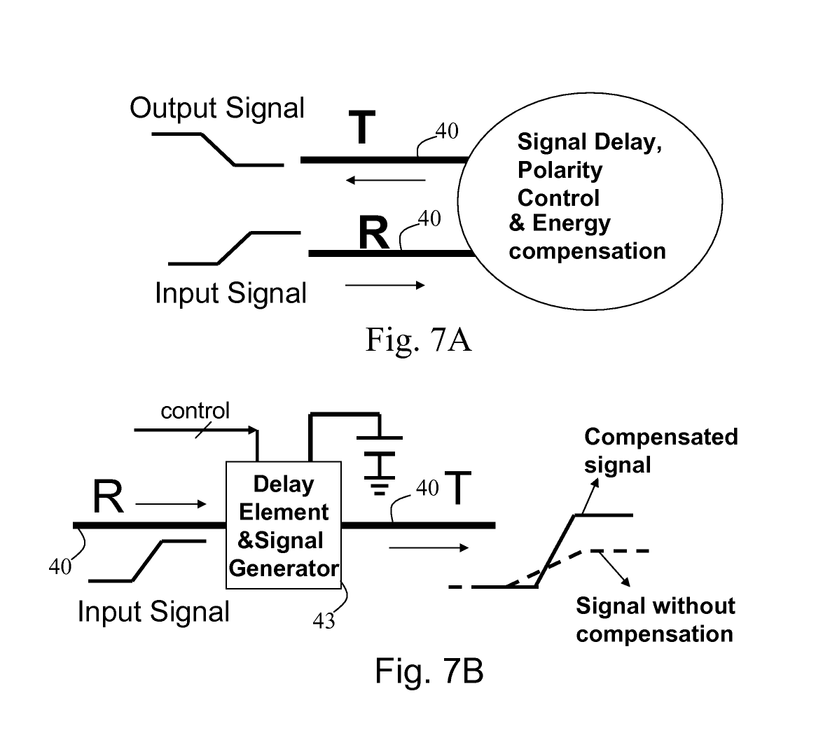

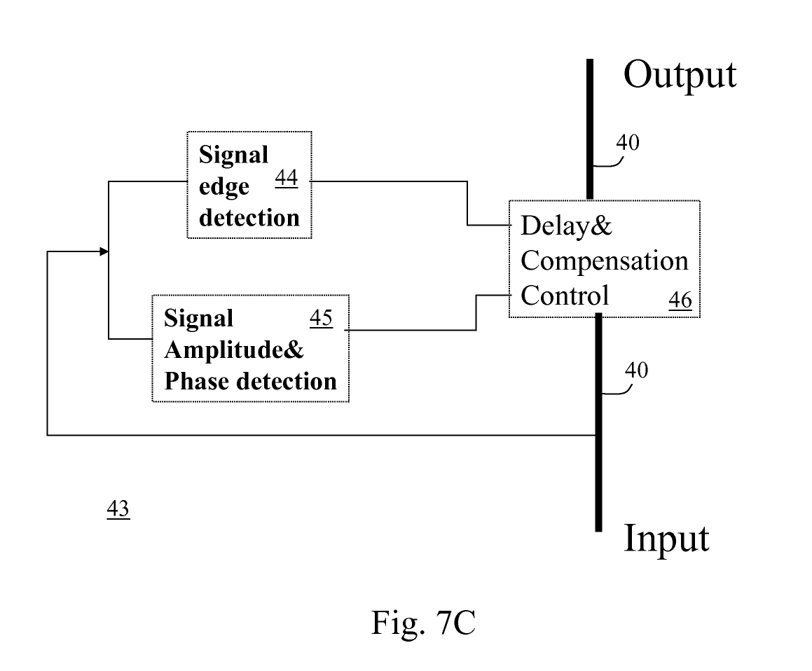

Returning to the details of FIG. 6A, the transceiver 31 carries out these operations on the transmission line 30. FIG. 6B is a block diagram for the transceiver 31. An Impedance Matching & Input Energy Capturing block 32 is used to capture the energy flowing out from the transmission line 30. In order to minimize reflection, the impedances between the output of the transmission line 30 and the input of the transceiver 31 are matched. A Control and Energy Storage & Compensation Device block 33 receives the energy from the block 32, stores the energy, and reshapes the waveform by timing control and energy compensation from a power supply 34. The block 33 controls the waveforms and compensates for the energy dissipated along the transmission line 30 to counter power dissipation which could cause the attenuation of the traveling waveforms. An Impedance Matching and Output Energy Transmission block 35 receives the waveform from the previous block 33 and transmits it to the transmission line 30 with maximum impedance matching with the input terminal of the transmission line 30. Again, the impedances of the output terminal of the block 35 and the input terminal of the transmission line 30 are matched.

Where the impedances of the receiver and transmitter terminals of the transceiver match that of the transmission lines 40, the impedance matching blocks 32 and 35 can be dispensed with. FIG. 7A shows one such realization of the transceiver wherein the input and the output impedance matching blocks are essentially the transmission lines 40. FIG. 7B shows the transceiver as a delay and signal generator block 43 which, connected to a power source 47, reshapes the input signal waveforms before sending them as output signals to compensate for energy dissipation. As illustrated in FIG. 7C, the block 43 includes a signal edge detection circuit 44, a signal amplitude and phase detection circuit 45, and a delay and the energy compensation circuit 46. The detection circuits 44 and 45 monitor the incoming signal waveforms on the transmission line 40 and generate control signals for the delay and the energy compensation circuit 46 which responsively reshapes the input signal waveforms before sending them as output signals at the proper time. Circuits to carry out these functions are well known to electrical circuit designers. For example, delay can be created with the transmission line itself, the simplest delay element, and with some combination of inductors and capacitors.

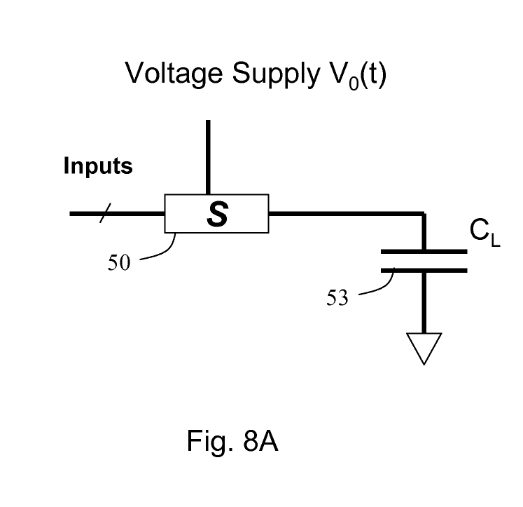

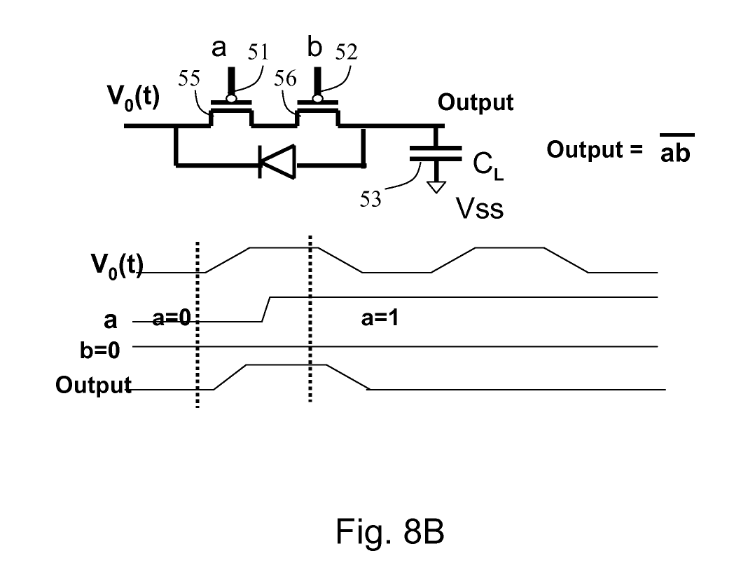

In accordance with one embodiment of the present invention, logic circuits are attached to the transmission line and are the loads on transmission line. In this embodiment, the logic circuitry is dynamic transfer gate logic, which can be modeled as a digital signal-controlled RC circuit. FIG. 8A is a simplified model for a dynamic logic gate. The logic gate switch 50 is controlled by a plurality of digital input signals. The switch 50 is bi-directional and forms a controlled resistance. The “ON” resistance of the switch 50 is R_{L}. The capacitive load 53 of the logic gate is C_{L}. When the dynamic power supply V₀(t) is switched on, the capacitive load is charged or discharged depending on the state of the input signals. For dynamic transfer logic gate operations, the input signals should arrive earlier than the rising waveform of the dynamic power supply V₀(t) of the transmission line.

FIG. 8B is an example of a dynamic transfer logic gate, a 2-input NAND logic gate. The logic gate switch is realized by two PMOS transistors 51 and 52 connected in serial. There is also a diode path 54 connected between the output and the two inputs 55 and 56 receiving input signals a and b respectively. In accordance with the dynamic transfer logic gate operations, the input signals a, b arrive before the power supply V₀(t) waveform arrives so that the load capacitor C_{L} is charged and the charge on the load C_{L} is be discharged when V₀(t) switches to logic low. See the accompanying timing diagrams in FIG. 8B. Though a NAND logic gate is shown, any logic gate that can be modeled by a controlled resistance, together with a load capacitance in series, can be feasibly implemented.

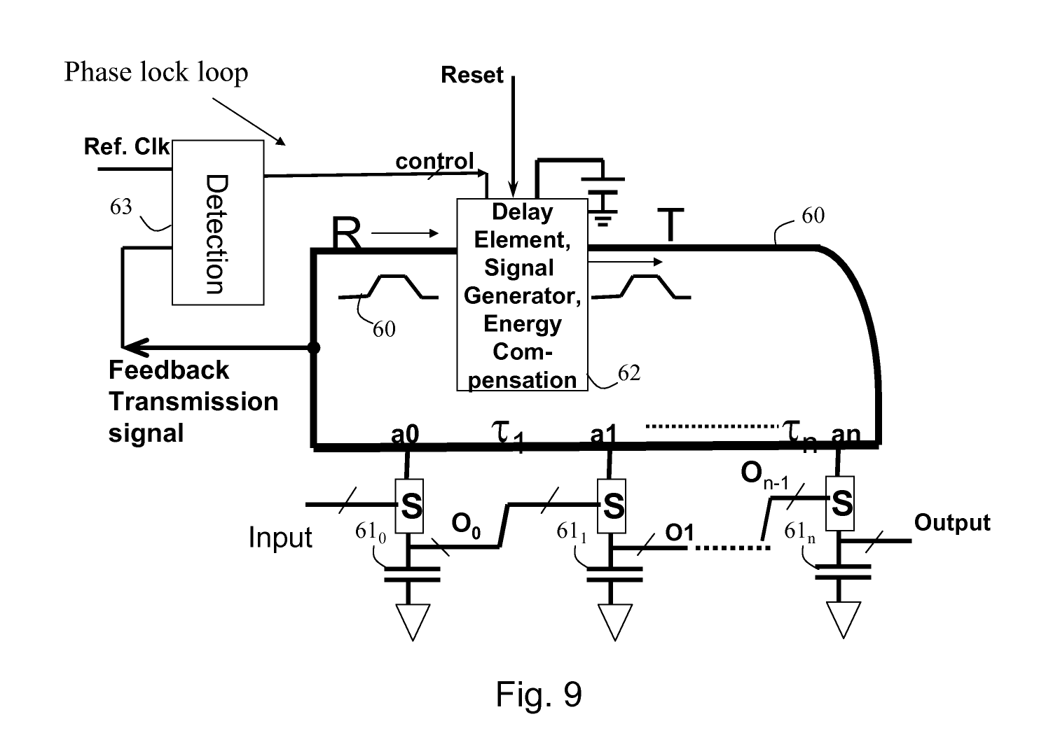

In FIG. 9, the modeled dynamic logic gates provide the load along the transmission line 60. The transmission line propagates a dynamic power supply for the dynamic logic gates 61 of which only three gates 61₀-61ₙ are shown. Between any two dynamic logic gates 61, the delay along the transmission line is long enough so that the state of the switch S for each logic gate 61₀-61ₙ is determined before the power supply signal on the transmission line arrives at that logic gate. In FIG. 9, the Input is a signal external to the logic gates 61, which arrives earlier than the power supply signal at node a0 propagating from the transmission line 60. The signal arrival at a0 charges the capacitive load C₀ of the logic gate 61₀ with the resulting output signal O₀. O₀ is then the input of the following logic gate 61₁. On the other hand, the power supply signal on the transmission line 60 propagates to node a₁ from node a0 with a propagation delay of τ₁. The delay τ₁ is long enough so that the signal O₀ arrives earlier to set the state of the switch S of the logic gate 61₁ before the power signal arrives at the node a₁ to charge the capacitive load C₁ of the logic gate 61₁. In this manner the resulting output signal O₁ controls the switch S of following logic gate, and the power signal on the transmission line 60 continues to propagate along the line 60 so that the capacitive loads of all the logic gates 61₀-61ₙ are charged/discharged.

The transceiver for the transmission line 60 is formed by a control block 62 and a detection block 63. The Input signal and power signal generated and propagated along the loop of the transmission line 60 is synchronized with an external reference clock signal to the detection block 63 with a phase locked loop mechanism formed by the feedback loop to the detection and block 63 and control block 62. The detection block 63 sends a control signal to the control block 62. In the manner described above, the control block 62 controls the power supply signal waveform to compensate for the energy dissipated along the transmission line 60. The power dissipation of the whole system is determined by the intrinsic impedance of the transmission line 60 and the power signal rise/fall time compared to the intrinsic delays of each logic gate 61₀-61ₙ, e.g., C₀R₀, C₁R₁, etc. The rise/fall time of the power supply signal on the transmission line 60 is also controlled by the control block 62. The efficiency of the loop of the transmission line 60 is therefore tunable by adjusting the transmission line loads, the rise/fall time of the power signals, and the quality of the transmission line 60.

Computer modeling of these circuitry with microstrip transmission lines powering dynamic logic gates and transceivers properly conditioning and timing the signal waveforms on the transmission lines with respect to the signals propagating through the logic gates have indicated power savings of nearly 90 percent at comparable operational clock speeds. Hence considerable power savings are achieved.

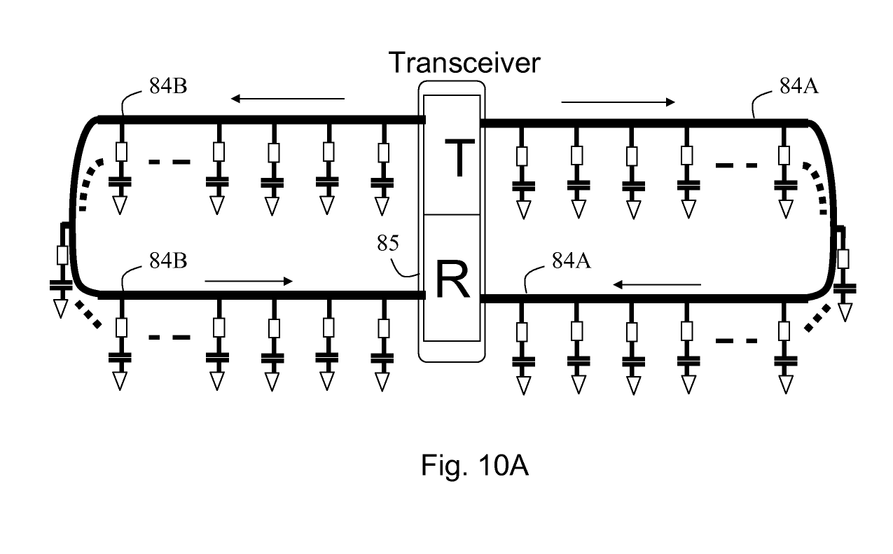

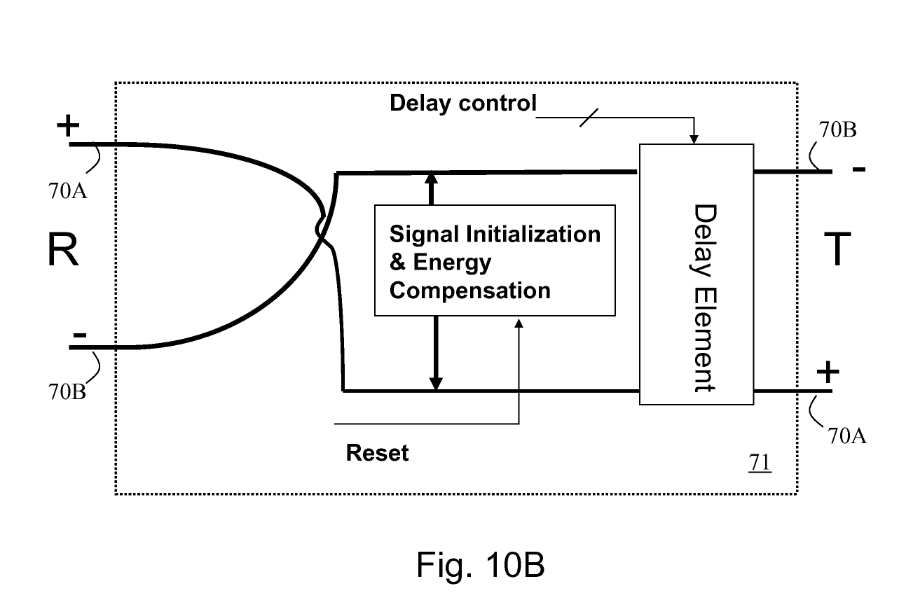

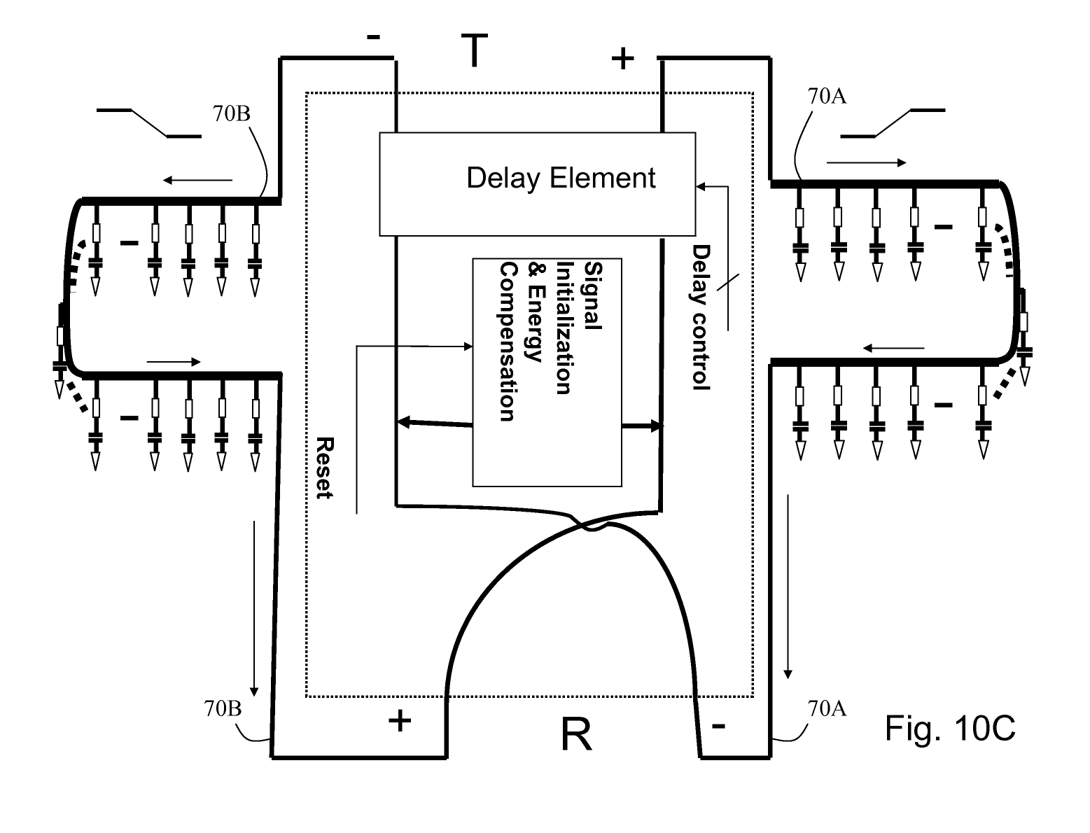

There are different ways of implementing the transceiver and the transmission lines in a system according to the present invention. In FIG. 10A a transceiver 85 drives two transmission lines 84A and 84B, each loop of transmission line driving loads, i.e., logic gates. In principle, one transceiver could drive more than two transmission line loops. A benefit of the FIG. 10A transceiver arrangement is that energy propagating in one loop, say, the transmission line 84A, can be recycled for the other loop, the transmission line 84B, and vice versa.

FIGS. 10B and 10C illustrates this type of arrangement in further detail. The transceiver 85 has receiver and transmitter terminals, which are denoted “R” and “T” respectively, which are each connected to the two transmission lines 84A and 84B. The transmission lines 84A and 84B have opposite signal phases; the “+” and “−” signs indicate that the signals propagating along the two lines 84A and 84B have opposite phases at the same locations. It should be noted that within the transceiver 85 the paths of the optical signals are swapped so that signals on the loop of transmission line 85A then travel on the loop of the transmission line 85B, and vice versa. Other blocks in the transceiver 85 play the same roles as signal delay control, signal phase and energy compensation as previously described.

FIG. 10C better illustrates how the loops of the two transmission lines 84A and 84B, each carrying loads (logic gates), are connected to the transceiver 85. The signals propagated in the two loops always have opposite phases for the same propagation distance and energy in one transmission line loop is recycled for the other loop. In a topological sense, the loops of the transmission lines 84A and 84B in FIGS. 10B and 10C may be considered as a Mobius strip in which the signals loop back and forth indefinitely between the two transmission lines. Analogously, for a Mobius loop connection as described, power can be constantly recirculated using the Mobius loop.

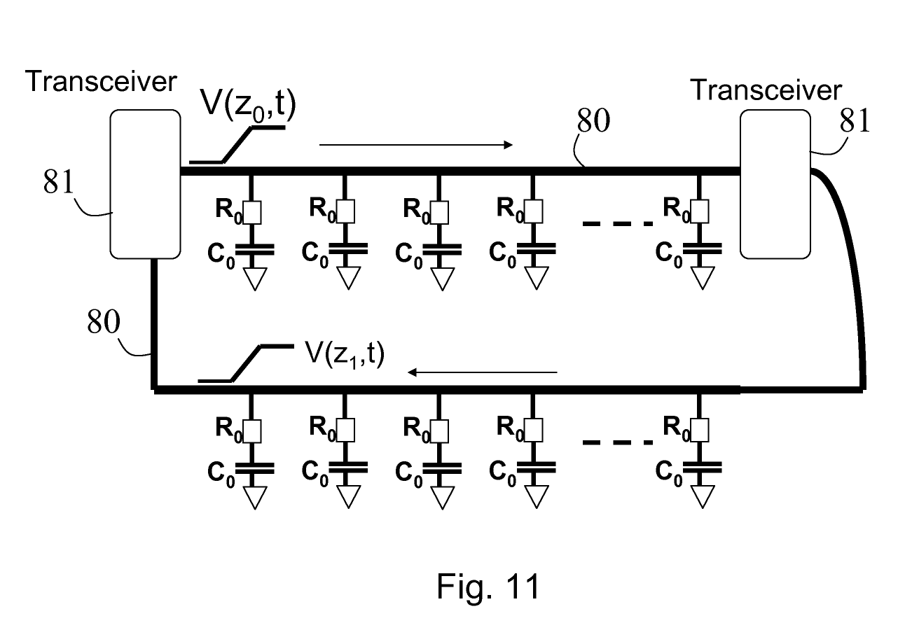

FIG. 11 illustrates another embodiment of the present invention. When a transmission line is too long, or the dissipation is high, the power supply waveform propagation along the transmission line has a high attenuation. To maintain the proper waveform, the waveforms must be reshaped periodically. For a transmission line 80with a large loop, such as shown in FIG. 11, multiple transceivers 81 are useful.

Thus these other transmission line loop topologies, such as shown in FIGS. 10A-10C and 11, can also be used as for the implementation of low power digital systems.

In one implementation, the transmission line of the invention distributes an alternating power signal to electronic circuits of an electronic system. The electronic circuits are the individual loads connected to the signal conductor of the transmission line. Any circuit or load may be connected and powered in such a manner. In the described implementation, the circuits are digital or logic circuits. In other implementation, the circuit may be other types of circuitry. The loads may be devices in a semiconductor technology such as MOS, FET, CMOS, NMOS, bipolar or BJT, or others.

Conceptually, the present invention may be scaled as desired to larger or smaller electronic systems. For example, in the case the electronic system may include multiple integrated circuits or chips, the loads may be individual chips or groupings of chips. As an example, loads may be entire boards of an electronic system, such as a computer, or the loads may be individual digital systems, computers, printers, or other components. By applying the energy recycling techniques of the invention, a greater amount of power savings can be realized by minimizing dissipated or lost power.

Furthermore, the concepts of the present invention may be applied at multiple levels. For example, different boards of in a computer may be connected using one transmission line and the technique of the present invention. And within an integrated circuit residing on one of the boards, the energy recycling of the invention may also be used. Thus there is energy recycling at a higher level and a lower level. There may be any number of levels, one, two, three, four, five, or more. This may serve to improve energy conservation even further.

The alternating power signal on the transmission line may be a pulse wave, sine wave, half sine wave, sawtooth wave, or other waveform. The signal typically alternates between (a) the voltage placed on the ground or reference plane and (b) a voltage used to power the electronic circuits. As discussed above in reference to FIG. 3, a transmission line of the invention may be used in an integrated circuit to power the circuitry of the integrated circuit.

The frequency of signal may be any frequency from 1 hertz to many gigahertz. In a specific implementation, the frequency of the signal on the transmission line is a frequency from about 200 megahertz to about 5 gigahertz. In another implementation, the frequency is from about 400 megahertz to about 5 gigahertz. In a specific implementation, the frequency is from about 200 to 300 megahertz, 300 to 400 megahertz, 400 to 500 megahertz, about 500 to 600 megahertz, about 600 to 700 megahertz, 700 to 800 megahertz, 900 to 1000 megahertz, about 1000 to 1100 megahertz, about 1100 to 1200 megahertz, 1200 to 1300 megahertz, 1400 to 1500 megahertz, about 1500 to 1600 megahertz, about 1600 to 1700 megahertz, 1700 to 1800 megahertz, 1900 to 2000 megahertz, 2000 to 2100 megahertz, about 2100 to 2200 megahertz, 2200 to 2300 megahertz, 2400 to 2500 megahertz, about 2500 to 2600 megahertz, about 2600 to 2700 megahertz, 2700 to 2800 megahertz, 2900 to 3000 megahertz, about 3100 to 3200 megahertz, 3200 to 3300 megahertz, 3400 to 3500 megahertz, about 3500 to 3600 megahertz, about 3600 to 3700 megahertz, 3700 to 3800 megahertz, 3900 to 4000 megahertz, 4000 to 4100 megahertz, about 4100 to 4200 megahertz, 4200 to 4300 megahertz, 4400 to 4500 megahertz, about 4500 to 4600 megahertz, about 4600 to 4700 megahertz, 4700 to 4800 megahertz, 4900 to 5000 megahertz, or higher than 5000 megahertz.

A duty cycle of the alternating supply signal may vary. For example the duty cycle may be 50 percent or any other percentage, such as 10, 20, 30, 32, 35, 36, 37, 38, 39, 40, 41, 42, 43, 44, 45, 46, 47, 48, and 49. A magnitude of the alternating supply signal may be any desirable value, such as 0 to 5 volts, 0 to 3.5 volts, 0 to 3.3 volts, 0 to 3 volts, 0 to 2.8 volts, 0 to 2.5 volts, 0 to 2.2 volts, 0 to 2 volts, 0 to 1.75 volts, 0 to 1.55 volts, 0 to 1.3 volts, an so forth. The supply voltage may be referred to as high when it is at the high voltage value (e.g., V_{DD} value) and low when it is at 0. The magnitude may depend on the process technology. The rise time and fall time of the alternating signal may also vary.

By using a transmission line to supply the alternating power, under real-life conditions, this allows higher frequencies to be used for the supply line than not using a transmission line. By having high frequencies for the supply line, this allows the circuitry connected to the transmission line to operate at high frequencies as well. In an implementation, by using the transmission line supply line (alternating power supply) of the invention, a power savings of about 90 percent may be achieved without any loss in the operating frequency of the circuit, as compared to a static, nonalternating power supply. Depending on the implementation, the amount of savings or efficiency may vary. For example, the efficiency may be in the range from 25 to 30 percent, 30 to 35 percent, 35 to 40 percent, 40 to 45 percent, 45 to 50 percent, 50 to 55 percent, 55 to 60 percent, 60 to 65 percent, 65 to 70 percent, 70 to 75 percent, 75 to 80 percent, 80 to 85 percent, 85 to 90 percent, 90 to 95 percent or greater. It is desirable to obtain the greatest amount of efficiency possible for a given die size and circuit complexity.

There may be any number of loads connected to and powered by the transmission line. For example, the number of loads may be 1, 2, 3, 4, 5, 6, 7, 10, 20, 25, 30, 100, 200, 300, 500, 800, 1000, 2000, 3000, 5000, 7000, 8000, 10000, 15000, 17000, 20000, 25000, 30000, 50000, 60000, 70000, 80000, 90000, 100000, 150000, 200000, 250000, 300000, 500000, 1000000, 2000000, or even greater numbers of loads. Each load may be an individual logic circuit, such as an inverter, NAND gate, NOR gate, AND gate, OR gate, or XOR gate. A load may be a circuit block such as portions of a memory array, adder, decoder, arithmetic logic unit, configurable logic element of a gate array or field programmable gate array, multiplexer, cross point switch, sense amplifier, branch prediction unit, cache, input buffer, output buffer, or others. The loads may be dynamic-type loads since the output of these loads may be at their correct output state (Boolean high or low) for only a certain period of time.

There may be multiple transmission line power supplies in a system, where different loads are connected to one transmission line power supply and another load in connected to another transmission line power supply. The circuit loads connected to the different transmission line power supply may be designed so they interact with other, such as an output of one circuit feeds another circuit, connected to a different transmission. There may be any number of reasons different transmission lines may be used for different circuits including that the transmission lines may provide different supply line voltages (i.e., voltage levels are different), the alternating signals are out of phase, have a different, or have a different waveform, or other difference, or any combination of these differences.

Because the power signal alternates on the transmission line, some of the electronic circuits of the system may receive power while others do not receive power. The circuits or loads receiving power may be considered active while the circuits not receiving power may be considered inactive or not active. The active circuit draws power while the inactive circuit does not.

The circuits generally have a parasitic output capacitance that needs to be charged or discharged, just as in the case of the CMOS inverter discussed earlier in this application. The magnitude of this capacitance and the current used to charge the parasitic capacitance gives an indication of the speed of the circuitry; the larger the current and smaller the capacitance, the more the speed of the circuitry is increased.

In an implementation of the invention, the transmission line supply is used to supply energy to enable the transition of a logic circuit connected to the transmission line. And the output state is stored at an output of the logic circuit. If the output is a high level, energy from the transmission line is used charge the output. If the output is a low level, energy from the output is discharged into the transmission line, where it is available to supply energy to charge other circuits when needed. In this manner, energy is recycled and conserved. In a typical DC power supply circuit, the dissipated energy is drained into the ground and not used again. In comparison, the technique and system of the invention provides much higher efficiency.

The system of the invention dissipates energy as heat during the transition of the semiconductor devices themselves. These energy losses may be relatively small, such as 10 percent for a system. However, these losses should be compensated for by using an external supply to recharge or resupply the transmission line. This keeps the transmission line at the desired level. More details on this were provided previously in this application.

Furthermore, to implement the invention, the inputs of a logic circuit should be ready and asserted at the circuits before the power signal is at the high level for that circuit. This is analogous to a set-up time situation for some types of logic circuits, such as registers, latches and flip-flops. There may be a hold time requirement for the logic circuit, where the inputs should be asserted for a certain length of time in order for the output to be correct.

Also, the logic circuits should be arranged appropriately. For example, if circuit 1 has an output that feeds into circuit 2, the circuitry should be arranged so that either (a) circuit 1 and 2 are active at the same time or (b) circuit 1 is active and then circuit 2 is active. The supply voltage should be high for circuit 1 to allow it to generate the right output and have it ready for circuit 2. Then the supply voltage should be high for circuit 2. More details on this were provided previously in this application.

Moreover, the invention provides advantages in a battery charging environment. Some battery chemistries are very sensitive to overvoltage, such as a 0.1 volt overcharge may cause the battery to overheat and possibly explode. By using a transmission line to supply the battery cells, this alleviates some of the danger of overvolting the battery cells. Since the supply circuitry simply recharges the transmission line, the batteries will see a more stable voltage and not see an overvolt situation.

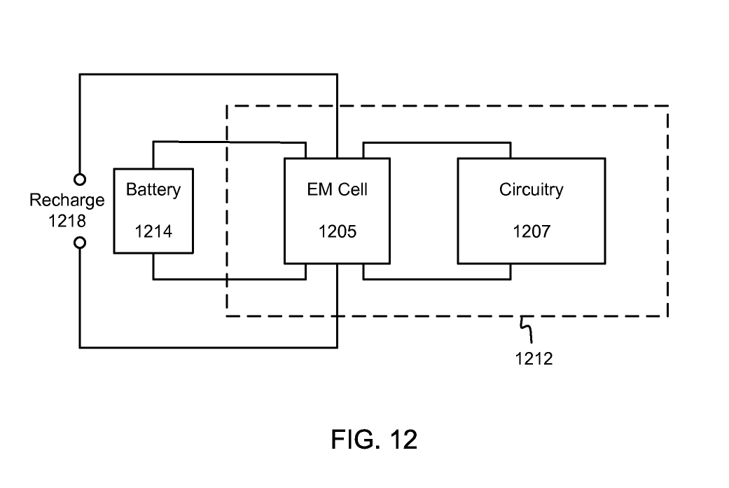

FIG. 12 shows an implementation of an EM-Cell used in conjunction with a battery to power circuitry. An EM-Cell 1205 supplies power to circuitry 1207 according to the principles of the invention. The circuitry may be an integrated circuit, part of an integrated circuit, or include circuits of multiple integrated circuits. As indicated by box 1212, the EM-Cell and circuitry 1207 formed on the same integrated circuit.

The EM-Cell provides energy efficient power to the circuitry. A battery 1214 connects to and charges the EM-Cell. This battery may be a rechargeable type. Some examples of rechargeable battery chemistries include lead acid, nickel cadmium, nickel metal hydride battery, lithium ion, and lithium polymer.

Note that the battery does not connect directly to the circuitry. Therefore, switching noise or other possible power line fluctuations caused by the circuitry will be less likely seen at the battery terminals. This minimizes the chances of the battery being subject to an overvolt situation, which may cause overheating or an explosion (especially when a more sensitive battery chemistry like lithium ion is used). The battery may be regards using terminals 1218, which charge the EM-Cell. When the EM-Cell is charged, this in turn charges or recharges the battery. Further, if it is desirable to run the circuitry off an AC wall supply (connected to a DC power supply), power may be supplied indefinitely through terminals 1218.

Therefore, while the description above provides a full and complete disclosure of the preferred embodiments of the present invention, various modifications, alternate constructions, and equivalents will be obvious to those with skill in the art. Thus, the scope of the present invention is limited solely by the metes and bounds of the appended claims.

1. An electrical circuit system for performing applications, said circuit system comprising:
an electrical circuit adapted to perform said applications;
a transmission line connected to said electrical circuit so that said transmission line supplies power to said electrical circuit, said electrical circuit operating as a load on said transmission line; and
a transceiver connected to said transmission line in a loop to transmit signal waveforms on said transmission line to power said electrical circuit and to receive said power supply signal waveforms after powering said electrical circuit, said transceiver timing and reforming said signal waveforms to compensate for any energy dissipation by said transmission line and said electrical circuit;
whereby energy carried on said transmission line is recycled and power dissipation of said electrical circuit system is substantially reduced.

2. The electrical circuit system of claim 1 further comprising
a plurality of electrical circuits adapted to form said applications;
a plurality of transmission lines, each transmission line connected to one of said electrical circuits so that said transmission line supplies power to said electrical circuit, said electrical circuit operating as a load on said transmission line; and
said transceiver to said plurality of transmission lines in loops to transmit signal waveforms on each transmission line to power said one of said electrical circuits and to receive said power supply signal waveforms after powering said one of said electrical circuits, said transceiver timing and reforming said signal waveforms to compensate for any energy dissipation by said transmission line and said one of said electrical circuits.

3. The electrical circuit system of claim 2 wherein said transceiver transmits on a first transmission line timed and reformed signal waveforms received from a second transmission line.

4. The electrical circuit system of claim 1 wherein said transceiver further comprises an output terminal connected to said transmission line to transmit said signal waveforms on said transmission line and a input terminal connected to said transmission line to receive to receive said signal waveforms on said transmission line, said output and input terminals having impedances respectively matched to said transmission line to minimize signal waveform reflections.

5. The electrical circuit system of claim 1 further comprising a plurality of transceivers connected to said transmission line along said loop, each transceiver transmitting signal waveforms on said transmission line to power said electrical circuit and receiving said power supply signal waveforms after powering said electrical circuit, said transceiver timing and reforming said signal waveforms to compensate for any energy dissipation by said transmission line and said electrical circuit.

6. The electrical circuit system of claim 1 wherein said electrical circuit comprises interconnected digital logic circuits.

7. The electrical circuit system of claim 6 wherein said digital logic circuits comprise dynamic transfer gate logic.

8. The electrical circuit system of claim 7 wherein electrical circuit system comprises an integrated circuit.

9. The electrical circuit system of claim 8 wherein said transceiver times said signal waveforms to arrive at a transmission line node connected to a power supply node of each logic gate after input signals arrive at said logic gate.

10. The electrical circuit system of claim 1 wherein said transmission line comprises a microstrip and a reference plane.

11. A method of adapting an electrical circuit system for performing applications, said method comprising
connecting an electrical circuit adapted to perform said applications to a transmission line so that said transmission line supplies power to said electrical circuit, said electrical circuit operating as a load on said transmission line;
connecting a transceiver to said transmission line in a loop so that said transceiver transmits signal waveforms on said transmission line to power said electrical circuit and receives said power supply signal waveforms after powering said electrical circuit; and
setting said transceiver to time and reform said signal waveforms to compensate for any energy dissipation by said transmission line and said electrical circuit;
whereby energy carried on said transmission line is recycled and power dissipation of said electrical circuit system is substantially reduced.

12. An integrated circuit comprising:
a transmission line structure comprising an active conductor and a ground plane conductor, where the active conductor carries an alternating power supply signal;
a first electronic circuit having a power connection coupled to the active conductor; and
a second electronic circuit having a power connection coupled to the active conductor.

13. The integrated circuit of claim 12 wherein the first and second electronic circuits are logic circuits.

14. The integrated circuit of claim 12 wherein the alternating power supply signal has a frequency above 400 megahertz.

15. The integrated circuit of claim 1 wherein the alternating power supply signal has a frequency above about 400 megahertz and less than about 4 gigahertz.

16. The integrated circuit of claim 1 wherein the alternating power supply signal is at least one of a pulse wave, sine wave, or sawtooth wave.

17. The integrated circuit of claim 1 wherein at a time period when the alternating power supply signal provides power to the first electronic circuit, the first electronic circuit will be active, and at a time period when the supply signal provides power to the second electronic circuit, the second electronic circuit will be active.

18. The integrated circuit of claim 17 wherein the first and second electronic circuits are not active during the same time period.

19. The integrated circuit of claim 17 wherein first energy stored in a load connected to the first electronic circuit is discharged into the transmission line.

20. The integrated circuit of claim 19 wherein energy of the transmission line, including the first energy, is used to charge a load connected to the second electronic circuit.

21. The integrated circuit of claim 12 wherein the first electronic circuit comprises:
a first transistor having a first gate node, wherein the first transistor is coupled between the active conductor and a first node; and
a second transistor having a second gate node, wherein the second transistor is coupled between the first node and an output node, and a load capacitance is at the output node.

22. The integrated circuit of claim 21 further comprising:
a inverter circuit coupled between the output node and the active node.

23. A method of operating an electronic circuit comprising:
providing a transmission line structure as an energy source for the electronic circuit;
during a first time period, capturing first energy from a first logic transition of a first circuit of the electronic circuit in the transmission line structure; and
during a second time period, supplying energy, which includes the first energy, from the transmission line structure to enable a second logic transition of a second circuit of the electronic circuit.

24. The method of claim 23 wherein the second time period is subsequent to the first time period.

25. A method of operating an electronic circuit comprising:
storing energy in a transmission line structure;
operating a logic circuit using the stored energy to determine a logic output based on at least one logic input to the logic circuit during a first phase;
capturing in the transmission line structure connected to the logic circuit a portion of the stored energy during the operation of the logic circuitry; and
transferring a portion of the captured energy back in the transmission line structure during a second phase.
